(19) United States
(12) Patent Application Publication
(10) Pub. No.: US 2025/0097471 A1
(43) Pub. Date: Mar. 20, 2025

(54) VALIDATING BITSTREAM COMPLIANCE AT RUNTIME FOR MULTIMEDIA STREAMING SYSTEMS AND APPLICATIONS

(71) Applicant: NVIDIA Corporation, Santa Clara, CA (US)

(72) Inventors: Swapnil Jagdish Rathi, Maharashtra (IN); Viranjan Vishwasrao Pager, Pune (IN); Bhushan Rupde, Maharashtra (IN); Kaustubh Purandare, San Jose, CA (US)

(21) Appl. No.: 18/370,762

(22) Filed: Sep. 20, 2023

(51) Int. Cl. H04N 19/65; H04N 19/172; H04N 19/46

(52) U.S. Cl. CPC H04N 19/65; H04N 19/172; H04N 19/46

(57) ABSTRACT

A processing device encodes a frame of a video. The processing device determines a reference checksum of the frame. The processing device adds the reference checksum to supplemental metadata associated with the encoded frame of the video. The processing device transmits the encoded frame and the supplemental metadata including the reference checksum to a recipient. The recipient is to use the reference checksum to verify an integrity of the frame.

### TECHNICAL FIELD

At least one embodiment of the present disclosure pertains to processing resources used to perform and facilitate video encoding and decoding. For example, one embodiment pertains to processors or computing systems used to facilitate bitstream compliance validation at runtime for multimedia streaming systems and applications.

### BACKGROUND

A video file in a raw (source) pixel format can occupy a very large memory space and require a large network bandwidth to transfer, which can be impractical for storage and/or livestreaming. For example, a typical high-definition video displays about 30 frames per second, many frames of which are often very similar to each other. A lot of information in such frames is typically redundant, allowing efficient compression. On one hand, there are typically only relatively minor changes that occur in the same position (e.g., coordinates) between subsequent frames (temporal redundancy). On the other hand, multiple (e.g., adjacent) regions in a given frame are often similar to each other (spatial redundancy), e.g., an image of the sky can extend over a large portion of a frame. As a result, in lieu of transmitting the actual pixel information (e.g., luminance and chromaticity) of each pixel, a codec can identify a reference block that is similar to a block being encoded (“predicted”) and provide to a decoder a suitable and compact mathematical representation of the difference (“delta”) between the actual source block and the predicted block. The reference block can be a block of a different (e.g., previous, or even subsequent) frame, a block of the same frame, or even a synthetic block generated according to some predetermined scheme (mode) based on a small number of reference pixels. Subsequently, instead of storing or livestreaming the actual frame of pixels, the codec can output a bit stream of encoded data, which largely contains instructions to the decoder about how to generate an approximation of the frame whose visual appearance is indistinguishable or very similar to the source frame. Video encoding/decoding engines are used to encode/decode videos in various formats, including H.264, H265, VP8, VP9, AV1, MPEG-2, and/or the like. Such encoding/decoding engines are used in video conferencing platforms, digital multimedia broadcasting, video and audio streaming applications, and/or the like.

### BRIEF DESCRIPTION OF THE DRAWINGS

The present disclosure is illustrated by way of example, and not by way of limitation, in the figures of the accompanying drawings.

FIG. 1 illustrates an example encoding system for efficient bitstream compliance validation at runtime, in accordance with at least one embodiment of the present disclosure.

FIG. 2 is an example architecture diagram of an encoder depicting encoding operations for efficient bitstream compliance validation at runtime, in accordance with at least one embodiment of the present disclosure.

FIG. 3 is an example architecture diagram of a decoder depicting decoding operations for efficient video bitstream compliance validation at runtime, in accordance with at least one embodiment of the present disclosure.

FIG. 4 is an example illustrating packetization of a bitstream within Network Abstraction Layer (NAL) units, in accordance with at least one embodiment of the present disclosure.

FIG. 5 depicts a flow diagram of an example method of encoding a frame of a video for efficient bitstream compliance validation at runtime, in accordance with at least one embodiment of the present disclosure.

FIG. 6 depicts a flow diagram of an example method of decoding a frame of a bitstream for efficient bitstream compliance validation at runtime, in accordance with at least one embodiment of the present disclosure.

FIG. 7A illustrates inference and/or training logic, according to at least one embodiment.

FIG. 7B illustrates inference and/or training logic, according to at least one embodiment.

FIG. 8 illustrates an example data center system, according to at least one embodiment.

FIG. 9 illustrates a computer system, according to at least one embodiment.

FIG. 10 illustrates a computer system, according to at least one embodiment.

FIG. 11 illustrates at least portions of a graphics processor, according to one or more embodiments.

FIG. 12 illustrates at least portions of a graphics processor, according to one or more embodiments.

FIG. 13 is an example data flow diagram for an advanced computing pipeline, in accordance with at least one embodiment.

FIG. 14 is a system diagram for an example system for training, adapting, instantiating and deploying machine learning models in an advanced computing pipeline, in accordance with at least one embodiment.

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

Encoding is an important process in digital media and communication as it allows for efficient compression of digital media (e.g., videos, audio, images, etc.) into an encoded bitstream. Encoders can utilize one or a combination of hardware, software, and/or firmware to significantly reduce data size without a significant loss of quality. Largely due to the compressed size of encoded bitstreams, encoding enables efficient storage of compressed digital media and reduces bandwidth for transmission of compressed media. Thus, encoded data can be efficiently transmitted and decoded at a receiving end, ensuring efficient and reliable communication of media. A decoder may receive the encoded data and convert it back to its original, uncompressed form for playback, display, or further processing.

Often, before new decoder implementations are deployed, the new decoder is subject to intensive testing to ensure that the decoder produces decoded bitstreams that are compliant with the codec standard specifications of interest. Decoded bitstream compliance testing and bit exactness validation is conventionally performed offline according to standardized procedures. In an illustrative example, the Joint Video Team (JVT) for collaboration and joint effort in the development of the High Efficiency Video Coding (HEVC)/H.265 and Advanced Video Coding (AVC)/H.264 follows a standardized testing and evaluation process. Conventional decoder validation tools, such as those that follow the JVT standardized testing and evaluation process, compare a test decoder's output with a known correct result stored within the device performing the decoder validation procedures after a test bitstream is decoded by the test decoder to ensure bit exactness and integrity of the output.

For example, a bitstream compliance test suite that includes a set of tests to evaluate a decoded bitstream can be provided. The test suite can cover various aspects that include semantics, encoding rules, and other requirements. Using the suite of compliance testing tools, a decoded bitstream provided by the decoder being tested can be compared against an expected output stored within a memory. In some instances, the decoded test bitstream can be compared against a compliant reference output. In some instances, a checksum value associated with a decoded frame of the decoded bitstream is stored in the memory and compared to a reference checksum value after the bitstream is decoded. In both instances, all frames of an encoded bitstream are decoded before comparison procedures are performed to determine bitstream compliance and integrity. Developers can refine and modify the decoder to address non-compliant aspects and iteratively retest the same bitstream using the compliance test suite. Because a frame (e.g., a frame of the decoded bitstream) early in the bitstream can ultimately be found to be non-compliant or lacking integrity, compliance systems that decode an entire test bitstream before comparing against a reference output or a reference checksum can needlessly waste time and computing resources associated with decoding the bitstream. Additionally, such compliance systems occupy memory space for storing decoded bitstream and/or checksums and consume processing resources associated with retrieving decoded bitstreams and/or checksums from a file input/output (IO), thereby increasing an overall latency of the system. However, conventional test suites are not capable of testing frames of a video in real time (e.g., before all of the video has been decoded).

One or more embodiments of the present disclosure include a mechanism to check decoded bitstream compliance at runtime, rather than decoding an entire bitstream prior to checking decoded bitstream compliance and checking the decoded bitstream offline thereafter. Specifically, the introduced technique utilizes supplemental metadata, such as supplemental enhancement information (SEI) messages, to store reference checksums. A reference checksum can refer to a checksum produced by the encoder and stored in within an SEI message. In an illustrative example, while encoding a frame of a video, the encoder can compute a reference checksum (e.g., using a Cyclic Redundancy Check (CRC) algorithm) of the frame and store the reference checksum within an SEI message included as part of a payload for a Network Abstraction Layer (NAL) unit embedded within the encoded bitstream. A transmitter can transmit the encoded bitstream with the inserted reference checksums to a receiver for decoding at a decoder. On a receiver side, the decoder analyzes the encoded bitstream with inserted checksums. The decoder can extract the embedded checksums from the encoded bitstream and use the extracted checksums as reference checksums. For example, the decoder can decode a frame of the encoded bitstream and compute a checksum of the decoded frame. The computed checksum can be compared to the reference checksum extracted from the bitstream to test the integrity of the decoded bitstream. Such checking of a current frame can be performed before some (e.g., all) of the video has been decoded in embodiments. Accordingly, if a problem is identified for one or more frame, then decoding of the video may be halted rather than decoding a remainder of the video, thus saving processor resources and time. Moreover, in embodiments a checksum retrieved from a decoded frame is not stored in memory, and then read from memory by a tester, saving one or more write and/or read operations generally associated with testing of decoders.

Since the introduced technique utilizes supplemental metadata to store reference checksums for each frame of a bitstream, it can allow a decoder to compare calculated checksums against reference checksums in real time (e.g., as frames are being decoded) for each frame of the bitstream and/or without performing operations to write to and read from memory. Accordingly, the decoding can be halted if the decoder generates a non-compliant bitstream rather than continuing to decode the bitstream. This can substantially reduce compliance test time in the case that any decode operation causes the decoder to generate a non-compliant bitstream. Moreover, the introduced technique can avoid unnecessary consumption of resources associated with retrieving decoded bitstreams and/or checksums from a file input/output (IO), thereby improving an overall performance of the system.

Solutions offered by conventional coding systems may not leverage supplemental metadata, such as SEI messages, to store reference checksums for decoded bitstream compliance/integrity validation. Such systems do not utilize checksums stored within supplemental metadata of an encoded bitstream to check compliance/integrity of the decoded bitstream at runtime.

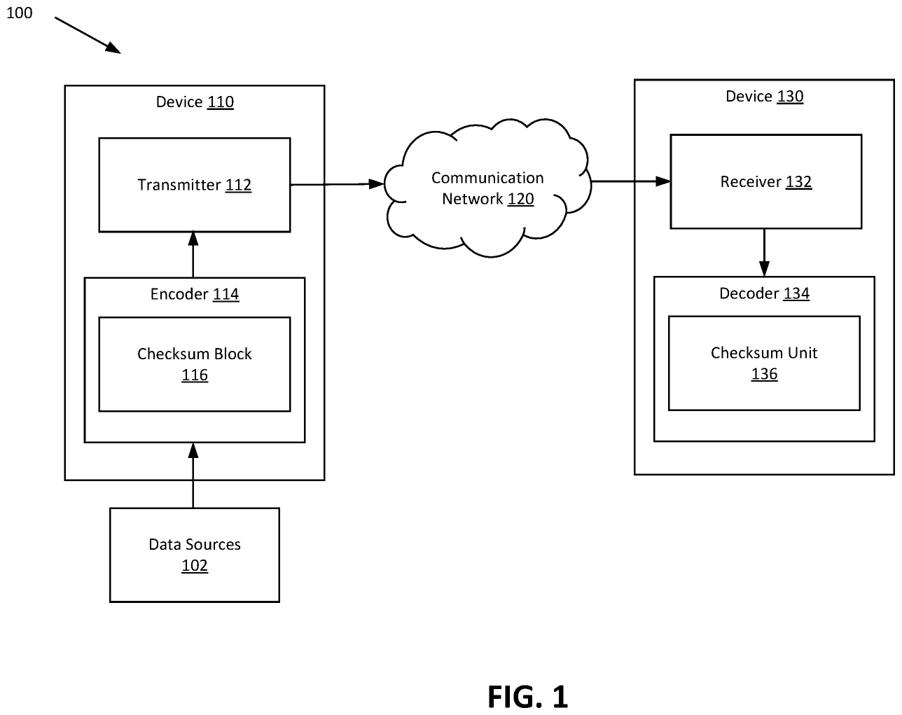

FIG. 1 illustrates an example system architecture 100 for efficient bitstream validation, in accordance with at least one embodiment of the present disclosure. The system architecture 100 (also referred to as “system” herein) includes a device 110 and a device 130 connected via a communication network 120. The system may further include one or more data sources 102 and/or a downstream device. The device 110 may include a transmitter 112 and an encoder 114. The device 130 may include a receiver 132 and a decoder 134. In at least one embodiment, the system 100 can be implemented as part of a bitstream testing framework. A bitstream testing framework can include a comprehensive collection of test cases designed to verify whether an encoded bitstream produced by an encoder or a decoded output produced by a decoder complies with specifications defined by a codec standard (e.g., an HEVC/H.265 codec standard as defined by JVT). For example, the testing framework can include a test to verify an ability of the decoder 134 to decode an encoded bitstream and produce an output that matches the original video, image, or audio. In some embodiments, system 100 may be implemented as part of a streaming service or a video conferencing platform or service.

In at least one embodiment, device 110 and device 130 can include, without limitation, a central processing unit (CPU), a graphical processing unit (GPU), a dedicated video encoding/decoding chip, a system-on-chip (SoC), a Field-Programmable Gate Array (FPGA), a cloud server with dedicated hardware for cloud-based encoding, and/or other processors. The devices 110 and 130 can include cache(s), memory, data store(s), and/or other components not illustrated. In at least one embodiment, the encoder 114 and the decoder 134 can be packaged on the same integrated circuit (e.g., as an SoC) as part of video processing pipeline to facilitate bitstream compliance testing. In such an embodiment, the encoder 114 and decoder 134 can interface via a dedicated hardware interface. In at least one embodiment, the device 110 and 130 can be disposed on separate circuit boards and directly connected (e.g., via a hardware interface). In at least one embodiment, the system 100 can be implemented within a live streaming environment to ensure data integrity as data is transferred over the communication network 120. For example, the device 110 and 130 can be separate computing devices connected via a local area network (LAN) or a wide-area network (WAN) (e.g., the internet). It can be noted that aspects and implementations of the present disclosure can be implemented within a live streaming environment to ensure data integrity and/or within a testing framework to ensure a decoder output produced by a decoder complies with one or more specifications defined by a codec standard.

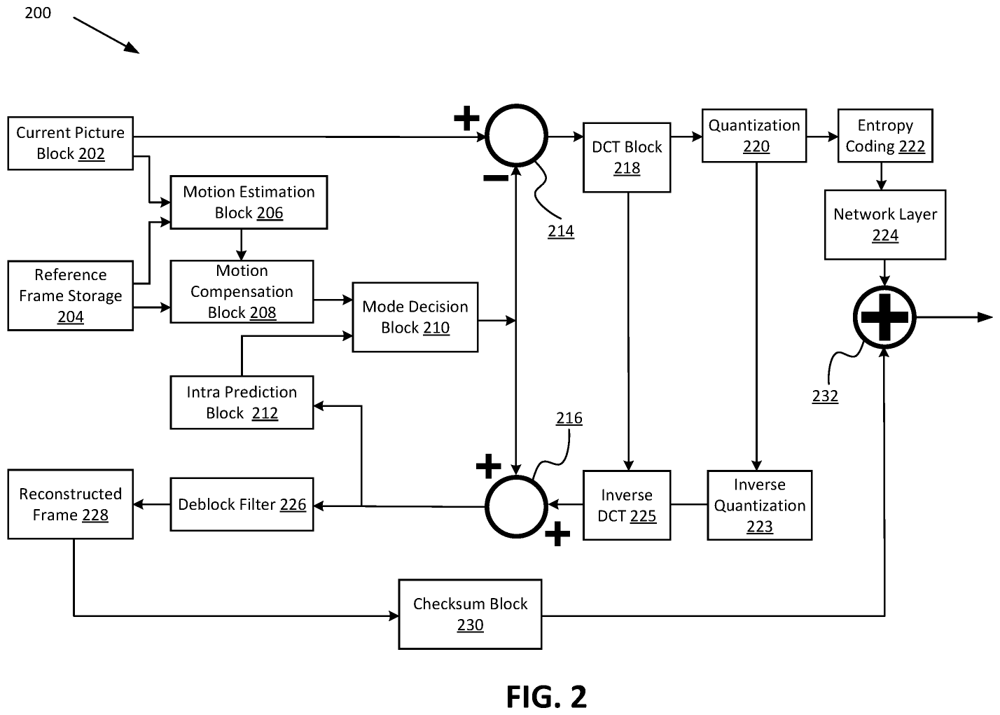

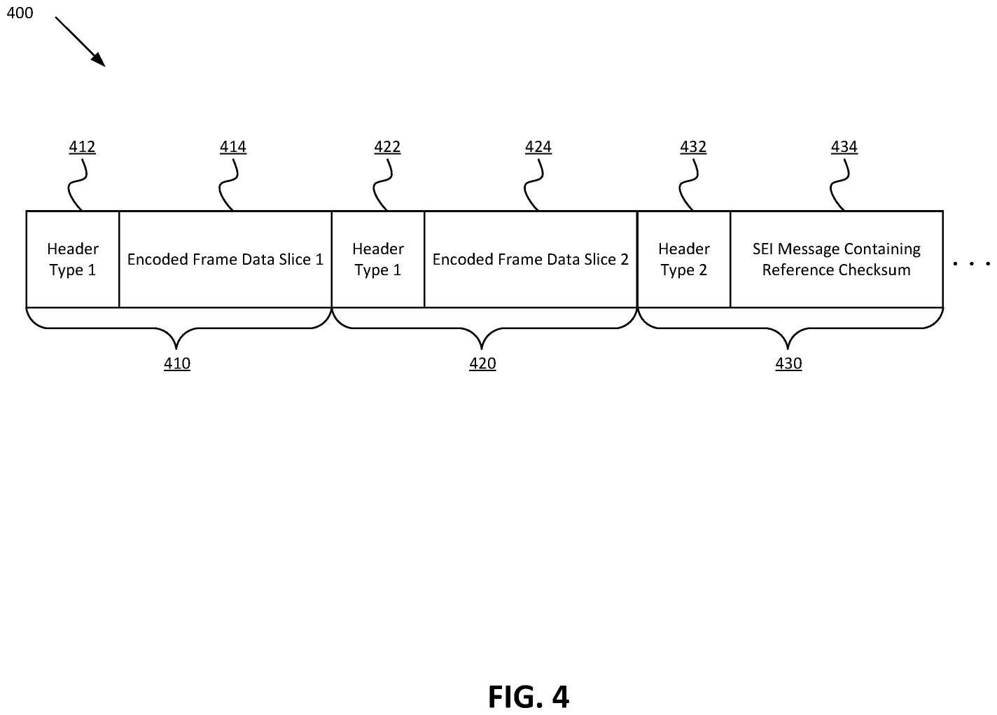

By way of example, and not limitation, encoder 114 can receive data from one or more data sources 102, such as a video camera, a transmission medium, a storage device, and the like. In at least one embodiment, the data sources 102 can include digital video or images captured from a digital image or video capturing device. Using a video by way of example, and not by way of limitation, the data sources 102 can provide frames of the video to the device 110 for encoding and transmission. The encoder 114 (e.g., an H.264 encoder) of the device 110 can encode the frames for transmission to the device 130. In particular, the encoder 114 can encode each frame of the provided video stream by converting the frame to a digital format (e.g., H.264 raw data), as described in detail below with respect to FIG. 2. In at least one embodiment, the encoder 114 can be a software implemented encoder or a dedicated hardware accelerated encoder configured to encode data substantially compliant with one or more data encoding formats or standards, including, without limitation, H.263, H.264 (AVC), H.265 (HEVC), H.266, VVC, EVC, AVC, AV1, VP8, VP9, MPEG4, 3GP, MPEG2, and any other video or multimedia standard formats. An encoded bitstream (e.g., a sequence of frames encoded by encoder 114) can be partitioned into Network Abstraction Layer (NAL) units and packetized for transmission over communication network 120 via transmitter 112. NAL units are conventions of certain video coding standards (e.g., AVC/H.264 and HEVC/H.265) used to contain elements and data associated with a bitstream. Each NAL unit can include a header to contain information about data types represented, and a payload that includes one or more encoded bits representing one or more frames or supplemental metadata (e.g., Supplemental Enhancement Information (SEI) messages), as described in detail below with respect to FIG. 4. NAL units can be packetized into network packets for transmission over the communication network 120 via the transmitter 112 or storage in embodiments. The transmitter 112 includes suitable software and/or hardware for outputting data signals, such an encoded bitstream, for transmission over the communication network 120.

The encoder 114 is configured to implement a checksum block 116. Before an encoded frame of video is transmitted or stored, the checksum block 116 can compute a reference checksum of the encoded frame. Checksums can provide functionality to enable the system 100 to verify an integrity of encoded frames and detect data corruption. The checksum block 116 can compute the reference checksum using a checksum algorithm such as a Cyclic Redundancy Check (CRC), Adler-32, and the like. In some embodiments, reference checksums computed during the encoding process can be stored within supplemental metadata associated with the encoded bitstream. Supplemental metadata can include additional information about the video stream including timing, synchronization, display orientation, synchronization, display orientation, captions, subtitles, and other information. In some embodiments, supplemental metadata can be Supplemental Enhancement Information (SEI) messages as defined by a video coding standard such as H.264 (AVC) and/or H.265 (HEVC), noting that other video coding standards can define a particular type of supplemental metadata that can be utilized by techniques described herein. SEI messages can be packaged into an NAL unit and inserted within the encoded bitstream. SEI messages can be included in an NAL unit inserted in the bitstream before a corresponding video frame (prefix), within the corresponding video frame (in-band), or after the corresponding video frame (postfix).

The receiver 132 of device 130 can receive the packetized encoded frame via the communication network 120. The device 130 can depacketize the packetized encoded frame to obtain the encoded frame transmitted by the transmitter 112. For example, to depacketize the packetized encoded frame, device 130 can reconstruct (e.g., combine) the plurality of packets used in transmission into the encoded frame (e.g., to generate the encode frame from the plurality of packets). The device 130 includes a decoder 134. Once the encoded frame is obtained, the decoder 134 can decode the encoded frame. In at least one embodiment, the decoder 134 can be a software implemented decoder or a hardware accelerated decoder. In at least one embodiment, the decoder 134 is included in the system 100 as part of a testing framework in which the decoder 134 is to be tested to verify an integrity of decoded data produced by the decoder 134 such that the decoded data is substantially compliant with one or more data encoding standards (e.g., as defined by JVT).

The decoder 134 can implement a checksum block 136. The checksum block 136 can extract a reference checksum stored within supplemental metadata of the encoded bitstream. For example, a reference checksum for a given frame of the bitstream can be extracted from an SEI message associated with the given frame. Once the frame is decoded, the checksum block 136 can compute (e.g., using the same method as checksum block 116 during encoding) a checksum of the given frame. The checksum block 136 can compare the reference checksum to the computed checksum to verify the integrity of the decoded frame (e.g., verify the decoded frame is compliant with one or more video coding standards, verify there was no corrupted frames during transmission, etc.). In at least one embodiment, if the checksum block 136 determines the decoded frame lacks integrity or is not compliant with one or more video coding standards (e.g., as defined by JVT), the decoder 134 can cease decoding subsequent frames of the bitstream. In the case that the decoder 134 produces a non-compliant decoded frame or a decoded frame that lacks integrity, compliance test duration can be substantially reduced as integrity and compliance can be determined at run time (e.g., while decoding frames of the bitstream). In embodiments, the reference checksum is removed from the metadata associated with a frame, a test checksum is computed for the frame, and the reference checksum and test checksum are compared all without performing a write to memory or read from memory (e.g., I/O) operation, which may significantly increase a speed of performing testing and/or reduce a processor and/or memory utilization associated with testing.

In at least one embodiment, the device 130 can be a client device configured to display (e.g. in the case that the decoded bitstream is compliant or has integrity) the decoded bitstream on a client display device (e.g., a screen or a monitor) to a user of the device 130. In at least one embodiment, the device 130 can be a server machine configured to provide (e.g., in the case that the decoded bitstream is compliant or has integrity) the decoded bitstream for display on a client device.

FIG. 2 is an example architecture diagram of an encoder 200 depicting encoding operations for efficient runtime video bitstream compliance validation, in accordance with at least one embodiment of the present disclosure. Encoder 200 can include similar elements illustrated by computing system 100, as described with respect to FIG. 1. It should be noted that elements of FIG. 1 can be used herein to help describe FIG. 2. The operations described with respect to FIG. 2 are shown to be performed serially for sake of illustration, rather than limitation. Although shown in a particular sequence or order, unless otherwise specified, the order of operations can be modified. Thus, the illustrated embodiments should be understood only as examples, and the illustrated operations can be performed in a different order, while some operations can be performed in parallel. Additionally, one or more operations can be omitted in at least one embodiment. Thus, not all illustrated operations are required in every embodiment, and other process flows are possible. In at least one embodiment, the same, different, fewer, or greater operations can be performed. In at least one embodiment, operations depicted in FIG. 2 can be performed by encoder 114 of FIG. 1. In at least one embodiment, operations depicted in FIG. 2 can be performed by a general CPU(s) or GPU(s) based on instructions generated by a software or firmware codec application.

The encoder 200 includes a current picture block 202 that may provide a current picture (e.g., a current frame of a video) to be encoded and transmitted as input to a motion estimation block 206. A reference frame storage 204 is coupled to provide reference frame information as input to the motion estimation block 206 and to the motion compensation block 208. The reference frame information can include information associated with previously encoded frames.

The motion estimation block 206 determines motion estimation information as output. The motion estimation block 240 may provide the motion estimation as input to the motion compensation block 208. In some embodiments, the encoder 200, and thereby the motion estimation block 206, is configured to process frames in fixed-size blocks. For example, the encoder 200 can process fixed-size macroblocks (MBs) that each cover a 16×16 pixel area. In some embodiments, the encoder 200 can process frames in variably-sized coding units (CUs). For example, a CU can have a size ranging from 4×4 pixels to 64×64 pixels. Whether fixed-size or variable-size, a rectangular region of pixels of pixel of video frame can be referred to generally herein as “blocks” or “pixel blocks.” The motion estimation block 206 can locate a block of the current frame that closely matches a block of a reference frame received from the reference frame storage 204. The motion estimation block 206 can generate motion vectors that indicate a degree of displacement of pixels between the reference frame and the current frame. The motion estimation block 206 may provide motion vectors to the motion compensation block 208.

The motion compensation block 208 may receive motion vectors from the motion estimation block 206. The motion compensation block 208 can shift pixel blocks from the corresponding reference frame to the current frame according to motion indicated by the received motion vectors. Motion compensation can reduce temporal redundancies between frames based on generated motion vectors. The motion compensation block 208 may provide motion vectors as input to a mode decision block 210.

An intraframe prediction block 212 may provide intraframe prediction information as input to mode decision block 210. The Intraframe prediction block 212 can predict pixels of neighboring (e.g., adjacent) blocks within the current frame. The intraframe prediction block 212 can exploit spatial redundancy between blocks of a frame to find patterns between blocks of pixels to achieve efficient video compression. The intraframe prediction block 212 is operably may provide intraframe prediction information to the mode decision block 210.

A mode decision block 210 can evaluate pixel prediction modes (e.g., intra prediction modes, inter frame prediction modes, etc.) to determine a suitable manner to represent blocks of pixels. For example, the mode decision block 210 can consider different inter prediction modes for each block of pixels based on motion vectors and block sizes. Inter prediction modes may utilize motion vectors to determine the most closely matching block in a reference frame to the block of the current frame. The encoder 200 can select a specific inter prediction mode that results in the smallest residual after motion compensation. The residual is the difference between the actual pixel values of the current block and the predicted pixels values. In another example, the mode decision block 210 can consider various intra prediction modes for each block of the current frame. As described above, intra prediction exploits spatial redundancy within the current frame to predict content of a pixel block. The mode decision block 210 can select an intra prediction mode for a current block that results in the smallest residual after the intra prediction. Each block of the current frame may be encoded using intra prediction and/or inter prediction. In either mode, a given block is constructed based on a reconstructed frame. In intra prediction mode, the predicted block may be constructed from previously-encoded blocks in the current frame. These blocks can be decoded and reconstructed. In inter prediction mode, the given block may be constructed by motion compensation prediction using one or more reference frames. The mode decision block 210 may provide a block prediction (whether an interframe prediction or an intraframe prediction) to a negative input of a combiner 214 (also referred to as an “subtractor” here) and a positive input to a combiner 216 (also referred to as a “adder” herein).

The combiner 214 can subtract the block prediction (received from mode decision block 210) from the corresponding block of the current frame (received from current picture block 220) to obtain a residual. Subtraction can be performed pixel-by-pixel to obtain the residual, Δ(x, y)=Source(x, y)−Pred.Block(x, y). The residual can be provided as input to the integer Discrete Cosine Transform (DCT) block 218. The DCT block 218 can perform an invertible transform, such as a DCT, and provide the transform to a quantization block 220. In at least one embodiment, other transforms can be performed including a Discrete Fourier Transform, Horizontal DCT, Vertical DCT, Asymmetric Discrete Sine (ADS) transform, Flipped ADS transform, Identify Transform, and/or another suitable transform. The DCT block 218 can produce a transformed residual, Δ(x, y)→Δ(kₓ, k_{y}). The DCT block 218 can provide the transformed residual as input to the quantization block 220.

The quantization block 220 can quantize (e.g., by forward quantization) the transformed residual to obtain a quantized residual. In at least one embodiment, the quantization procedure can include the transformed residuals (e.g., element-by-element) by a set of quantized transform coefficients to obtain a quantized residual, Δ(kₓ, k_{y})→Δ_{Q}(kₓ, k_{y}). The quantization procedure can cause components of the transformed residual to turn to zero such that the quantized residual includes fewer nonzero elements than the transformed residual. Quantization can thereby remove information that is less visually important, allowing for greater compression. The Quantization block 220 can provide the quantized residual as input to an entropy coding block 222.

The entropy coding block 222 can receive the quantized residual and further compress the quantized residual using entropy coding techniques such as Huffman coding or arithmetic coding to produce an encoded bitstream. In at least one embodiment, other coding data can be provided to the entropy coding block 222 such as a predicted block, an indication of the type of prediction used (inter-frame, intra-frame), motion vectors, prediction mode, the type of discrete transform being used to transform the residual, identification of the quantization coefficient, and the like. A network layer 224 may receive the compressed bitstream (also referred to as “encoded bitstream” herein) from the entropy coding unit 222. The network layer 224 can include one or more units, each with a header and a payload that can be sent as packets over a network or stored as data that may constitute the encoded bitstream. In some embodiments, the network layer 224 can be a network abstraction layer (NAL) associated with video codecs based on the H.264 (AVC) and H.265 (HEVC) standards. For example, a portion (e.g., a frame or a slice of a frame) of the encoded bitstream can be contained within a payload of an NAL unit for transmission. In some embodiments, the network layer 224 can refer to the general functionality of other codecs (e.g., VP9, AV1, etc.) that employ a concept of dividing an encoded bitstream into multiple self-contained packets for transmission over a network.

The quantization block 220 can additionally provide the set of quantized transform coefficients as input to an inverse quantization block 223 to initiate a feed backward portion of the encoder 200. The feed backward portion of the encoder 200 can include the inverse quantization block 223, an inverse DCT block 225, the combiner 216, a deblock filter 226, and/or a reconstructed frame 228. The inverse quantization block 223 can produce a reconstructed version of the transformed residual produced by the DCT block 218. The inverse quantization block 223 can produce the reconstructed version of the transformed residual by multiplying (e.g., element-by-element) the quantized residual by the quantization coefficients. In at least one embodiment, because rounding can be performed during the forward quantization transform (at quantization block 220), the inverse quantized transform, Δ′(kₓ, k_{y}), may not generally match the transformed residual, Δ(kₓ, k_{y}), produced by the DCT block 218.

The inverse quantization block 223 may provide the reconstructed transformed residual to the inverse DCT block 225. The inverse DCT block 225 can produce a reconstructed version of the residual output by the combiner 214. The inverse DCT block 225 is coupled to provide the reconstructed residual to a positive input of the combiner 216. Mode decision block 210 may additionally provide a block prediction as input to the combiner 216. Due to the difference between the quantization and the inverse quantization, application of the inverse DCT to the inverse quantized transform, Δ′(kₓ, k_{y})→Δ′(x, y), therefore, can generate a reconstructed residual, Δ′(x, y), that is different from the residual, Δ(x, y), produced by the subtractor 214.

The adder 216 can add the block prediction (received from mode decision block 210) to the reconstructed residual (received from inverse DCT block 225) to obtain unfiltered reconstructed frame information. Addition can be performed pixel-by-pixel and the unfiltered reconstructed frame information can be obtained, for example as follows, Recon.Frame Info.(x, y)=Pred.Block(x, y)+Δ′(x, y). The reconstructed frame information can be provided as input to an intra prediction block 212 and a deblock filter 226.

The reconstructed frame information can be processed by the deblock filter 226. The deblock filter 226 can select from a number of filters recognized by the codec standard being used and further determine various filter parameters to enhance visual quality of reconstructed blocks of the reconstructed frame, including removal of boundary and other artifacts created during block prediction and reconstruction. In some embodiments, available filters can include a deblocking filter that removes visible block boundaries between neighboring blocks of the frame. For example, the deblock filter 226 can identify the value of discontinuity of luma and/or chroma values across the boundary and spread this value over a number of pixels. The extent of the spread can be among the parameters determined by deblock filter 226. Additionally, deblock filter 226 can apply a constrained directional enhancement filter (CDEF) to remove ringing artifacts near depictions of sharp edges of various objects. More specifically, because the quantization transform irreversibly reduces or eliminates some short-wavelength harmonics (which are important for imaging of sharp edges), CDEF can compensate for the loss of such harmonics. CDEF can identify the most likely direction of edges, e.g., by identifying lines of a constant intensity and lines of the largest intensity gradients. In at least one embodiment, identification of such lines may be performed by identifying and minimizing a sum of square differences (SSD) for directions that best match directional patterns of the block. After identifying the direction of the block, CDEF can sharpen the depictions of the edges in the block by choosing the filter strength along the determined direction and across this direction. In at least one embodiment, deblock filter 226 can also apply a loop restoration (LR) filter to the block. The LR filter further improves edge quality and noise reduction using a number of filters, such as a self-guided filter, a Wiener filter, or a combination of the self-guided filter and the Wiener filter. The reconstructed frame 228 produced by the deblock filter 226 can then be provided as input to a checksum block 230.

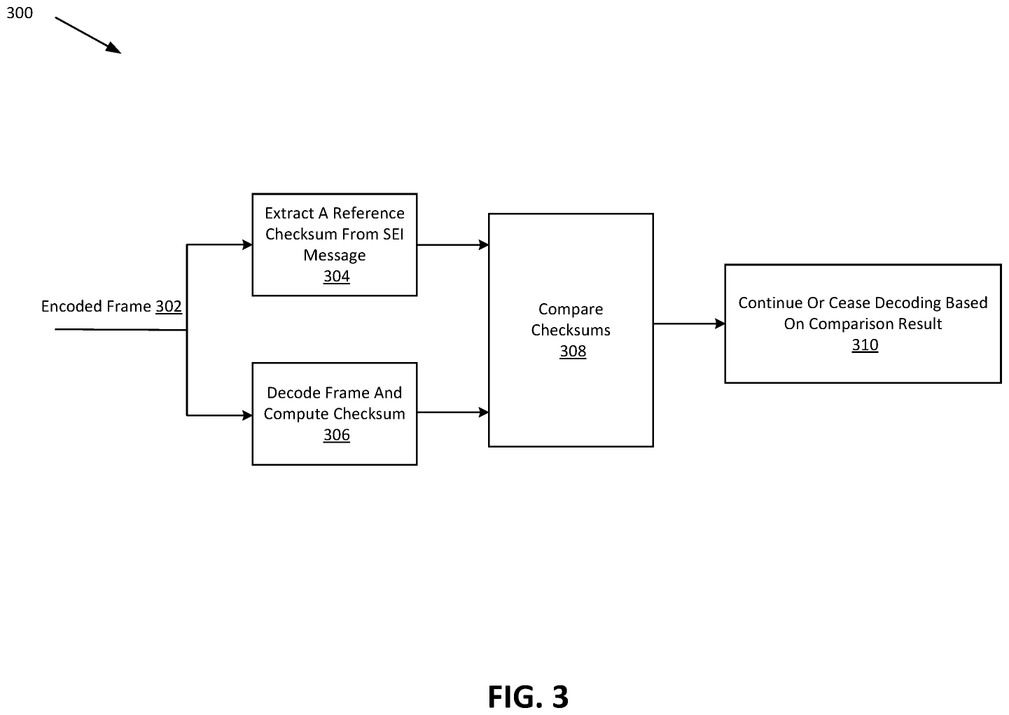

The reconstructed frame output by the deblock filter 226 can be received by the checksum block 230, which computes a reference checksum based on the reconstructed frame. The reference checksum is a value derived from the reconstructed frame that may be used to verify the integrity of the frame on a receiving and and/or after being decoded on a receiving end. For example, on a receiving end, a decoder can compute its own checksum and compare it with the reference checksum computed by the encoder 200 to verify that the decoded frame is the same as the original, unencoded frame. To compute the checksum, the checksum block 230 can use a checksum calculation algorithm (e.g., CRC, Adler-32, a hash function (e.g., MD5, SHA-1, etc.), and the like) to process pixel values or data within the frame to generate the reference checksum value. The reference checksum value can be transmitted or stored in association with the corresponding frame for a decoder (e.g., decoder 300 of FIG. 3) to use to verify the integrity of the frame and determine whether the decoder produces an expected output.

At operation 232, a reference checksum for a frame can be stored within supplemental metadata contained within a payload of a unit of the network layer 224 corresponding to the frame. For example, the reference checksum can be stored within a SEI message of a payload of an NAL unit, according to the H.264 (AVC) and H.265 (HEVC) coding standards. In at least one embodiment, a NAL unit can be self-contained and independently decodable such that each NAL unit contains all information necessary for a decoder to decode the NAL unit. Each NAL unit can be transmitted as a packet or stored in a data store for subsequent depacketization and decoding (e.g., via decoder 300 of FIG. 3). A payload of an NAL unit in certain video coding standards contains encoded video data for a specified unit. In at least one embodiment, a payload of a NAL unit can include encoded data for an entire frame of a video. In at least one embodiment, a payload of a NAL unit can contain encoded data for a portion (slice) of a frame, and multiple NAL units can be combined to reconstruct a complete frame during decoding. In at least one embodiment, a payload of a NAL unit can include one or more SEI messages that include auxiliary information to enhance decoding and presentation of video frames. For example, SEI messages can include picture timing, buffering requirements, subtitles, display colorimetry, and the like. In at least one embodiment, the reference checksum can be included in a dedicated SEI message. In at least one embodiment, a video coding standard/specification (e.g., the HEVC/H.265 standard) can be updated to call for the storage of reference checksums in SEI messages. In at least one embodiment, the SEI message containing the reference checksum can be encoded according to syntax and rules specified by the utilized video coding standard. Additional details regarding the structure of NAL units and SEI messages are provided below with respect to FIG. 4. It should be noted that the exact details of the encoding process can vary depending on the video coding standard used, and the above-described example is used by way of example, and not by way of limitation.

FIG. 3 is an example architecture diagram of a decoder 300 depicting decoding operations for efficient runtime video bitstream compliance validation, in accordance with at least one embodiment of the present disclosure. The decoder 300 can be a software implemented decoder or a dedicated hardware accelerated decoder in embodiments. In at least one embodiment, the decoder 300 can be implemented within a testing framework to determine whether the decoder produces and expected output (e.g., reliably decodes the data while maintaining data integrity) and/or an output that adheres to specifications of a video coding standard (e.g., H.264, H.265, etc.), for example, as defined by JVT. In at least one embodiment, the same, different, fewer, or greater operations can be performed than those shown. In at least one embodiment, operations depicted in FIG. 3 can be performed by decoder 134 of FIG. 1. In at least one embodiment, operations depicted in FIG. 3 can be performed by a general CPU(s) or GPU(s) based on instructions generated by a software or firmware codec application.

At operation 302, the decoder 300 can receive an encoded frame of a bitstream from a transmitter (e.g., transmitter 112 of FIG. 1) or from a data store (e.g., via a file I/O). In at least one embodiment, the encoded frame of the bitstream can be packetized within one or more NAL units.

At operation 304, the decoder 300 can extract a reference checksum (e.g., reference checksum computed by checksum block 230 of FIG. 2) from an SEI message associated with the encoded frame. To extract the reference checksum from the SEI message, the decoder 300 can parse a NAL unit to identify the SEI messages. The NAL unit can include multiple SEI messages, each with a specific type and content. The decoder 300 can parse the SEI messages included within the NAL unit to identify the SEI message containing the reference checksum. In at least one embodiment, the SEI message containing the reference checksum can be encoded. The decoder 300 can decode the SEI message to extract the reference checksum from the SEI message.

At operation 306, the decoder 300 can decode the frame and compute a checksum for the decoded frame. The decoder 300 can parse NAL unit headers and payloads associated with the frame to extracted encoded data. The decoder 300 can decode encoded symbols back to their original values utilizing techniques such as context-adaptive variable-length coding (CAVLC), on context-adaptive binary arithmetic coding (CABAC), and the like. The decoder 300 can perform inverse quantization, inverse DCT, inter-frame prediction, and/or a deblock filter (as described above with respect to the feedback portion of the encoder 200 of FIG. 2) to obtain a reconstructed (decoded) frame. It should be noted that the exact details of the decoding process can vary depending on the video coding standard used, and the above-described example is used by way of example, and not by way of limitation. The decoder 300 can compute a checksum using the same checksum algorithm as the algorithm used by an encoder of the bitstream to ensure consistency and compatibility between the encoding and decoding processes. To compute the checksum, the decoder can use a checksum calculation algorithm (e.g., CRC, Adler-32, a hash function (e.g., MD5, SHA-1, etc.), and the like) to process pixel values or data within the frame.

At operation 308, the decoder 300 can compare the reference checksum and computed checksum to verify data integrity of the encoded bitstream. If the reference checksum dose not match the computed checksum, it indicates that there may have been errors during encoding, decoding, and/or transmission (e.g., packet loss or corruption).

At operation 310, the decoder 300 can continue or cease decoding of subsequent frames of a bitstream based on the comparison result. Because the reference checksum for a given frame is inserted within an SEI message associated with the given frame, the decoder 300 can perform the comparison between the reference checksum and the compute checksum as the given frame is decoded (e.g., at runtime) and/or without performance of write and/or read (e.g., I/O) operations to/from memory of a device comprising the decoder 300. Accordingly, the decoder 300 can immediately cease decoding subsequent frames of the bitstream in response to determining that the reference checksum and the computed checksum for the given frame do not match. In response to determining that the reference checksum and the computed checksum match, the decoder 300 can continue decoding subsequent frames of the bitstream.

FIG. 4 is an example illustrating packetization of a bitstream 400 within Network Abstraction Layer (NAL) units, in accordance with at least one embodiment of the present disclosure. As shown in FIG. 4, there are three NAL units within the illustrated portion of the bitstream 400: NAL unit 410, NAL unit 420, and NAL unit 430. Each of the NAL units 410, 420, and 430 include a NAL unit header and a NAL unit payload. The NAL unit header contains information about the NAL unit type and characteristics that are used by a decoder to identify the type of data contained in the NAL unit. The header can include fields such as NAL unit type, reference ID (for decoding order), type-specific syntax elements, and/or the like. The payload can vary according to the NAL unit type. In an illustrative example, the NAL unit 410 includes a first header 412 with a first type and a first payload 414. The first header 412 is a first type that indicates the first payload 414 includes encoded video data. Specifically, the first payload 414 includes encoded video data for a first slice (portion) of a first frame of the bitstream 400. The NAL unit 420 includes a second header 422 with a first type and a second payload 424. The second header 422 is a first type that indicates the second payload 424 includes encoded video data. Specifically, the second payload 424 includes encoded video data for a second slice (portion) of the first frame of the bitstream 400. The NAL unit 430 includes a third header 432 with a second type and a third payload 434. The third header 432 is a second type that indicates the third payload 434 includes Supplemental Enhancement Information (SEI) messages. Multiple SEI message can be concatenated within the third payload 434 where each SEI message includes supplemental metadata to assist decoding, presentation, and/or playback of the video data contained within the first payload 414 and the second payload 424. For example, SEI messages can include information such as picture timing, subtitles, colorimetry, buffering requirements, and the like. In at least one embodiment, the third payload 434 can include an SEI message containing a reference checksum for the first frame. In at least one embodiment, the checksum SEI message can be included in a custom SEI message field or a dedicated SEI message field for storing reference checksums. In at least one embodiment, a reference checksum SEI message type can be included in a standardized coding specification (e.g., the H264 and/or H265 coding specification).

It can be noted that while the NAL unit 430 including the reference checksum is illustrated as being inserted within the bitstream 400 after the corresponding video frame (postfix), the NAL unit can be inserted in the bitstream 400 before the corresponding video frame (prefix), or the reference checksum can be stored within one or both of the NAL units 410-420 (in-band).

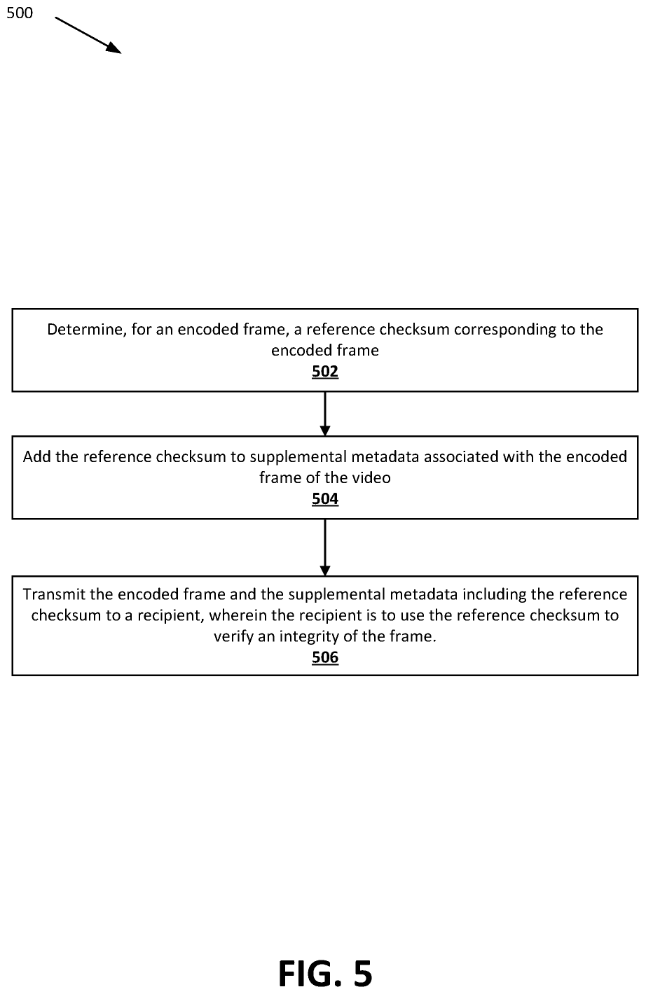

FIG. 5 depicts a flow diagram of an example method 500 of encoding a frame of a video for efficient bitstream compliance validation at runtime, in accordance with at least one embodiment of the present disclosure. The method 500 can be performed using processing logic that can include hardware (e.g., one or more computing devices, circuitry, dedicated logic, microcode, hardware of a device, integrated circuit, etc.), software (e.g., instructions running or executing on a processing device), or a combination thereof. In at least one embodiment, the method 500 can be performed by a non-transitory computer-readable medium comprising instructions that, responsive to execution by a processor, cause the processor of a computing system to perform operations described herein. In at least one embodiment, the method 500 can be performed by a hardware encoder, a software encoder, or a combination of a hardware encoder and a software encoder. Although shown in a particular sequence or order, unless otherwise specified, the order of the operations can be modified. Thus, the illustrated embodiments should be understood only as examples, and the illustrated operations can be performed in a different order, and some operations can be performed in parallel. Additionally, one or more operations can be omitted in various embodiments. Thus, not all operations are required in every embodiment.

At operation 502 of method 500, processing logic (e.g., encoder 200 of FIG. 2) can determine, for an encoded frame, a reference checksum (e.g., as determined by checksum block 203 of FIG. 2) corresponding to the encoded frame.

At operation 504 of method 500, processing logic can add the reference checksum to supplemental metadata associated with the encoded frame of the video. In at least one embodiment, the supplemental metadata includes a supplemental enhancement (SEI) message included within a payload of a Network Abstraction Layer (NAL) unit associated with a video coding standard (e.g., H.264, H.265, etc.).

At operation 506 of method 500, processing logic can transmit the encoded frame and the supplemental metadata including the reference checksum to a recipient, where the recipient is to use the reference checksum to verify an integrity of the frame. In at least one embodiment, to determine the reference checksum of the frame, the processing logic can decode the encoded frame to obtain a decoded frame and compute the reference of the decoded frame. For example, the reference checksum can be computed at a feedback portion of a decoder, as illustrated with respect to FIG. 2. In at least one embodiment, the reference checksum of the frame is determined using a cyclic redundancy check (CRC) algorithm.

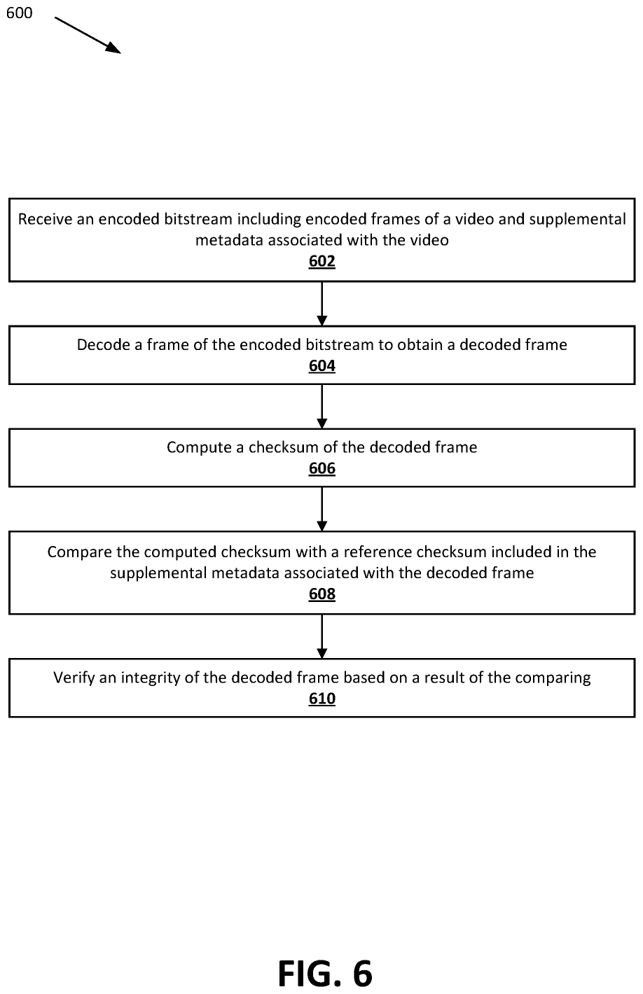

FIG. 6 depicts a flow diagram of an example method of decoding a frame of a bitstream for efficient bitstream compliance validation at runtime, in accordance with at least one embodiment of the present disclosure. The method 600 can be performed using processing logic that can include hardware (e.g., one or more computing devices, circuitry, dedicated logic, microcode, hardware of a device, integrated circuit, etc.), software (e.g., instructions running or executing on a processing device), or a combination thereof. In at least one embodiment, the method 600 can be performed by a non-transitory computer-readable medium comprising instructions that, responsive to execution by a processor, cause the processor of a computing system to perform operations described herein. In at least one embodiment, the method 600 can be performed using a hardware decoder, a software decoder, or a combination of a hardware decoder and a software decoder. Although shown in a particular sequence or order, unless otherwise specified, the order of the operations can be modified. Thus, the illustrated embodiments should be understood only as examples, and the illustrated operations can be performed in a different order, and some operations can be performed in parallel. Additionally, one or more operations can be omitted in various embodiments. Thus, not all operations are required in every embodiment.

At operation 602 of method 600, processing logic can receive an encoded bitstream including encoded frames of a video and associated supplemental metadata. In at least one embodiment, the supplemental metadata includes a supplemental enhancement information (SEI) message included within a payload of a Network Abstraction Layer (NAL) unit associated with a video coding standard (e.g., H.264, H.265, etc.).

At operation 604 of method 600, processing logic (e.g., decoder 300 of FIG. 3) can decode a frame of the encoded bitstream to obtain a decoded frame.

At operation 606 of method 600, processing logic can compute a checksum of the decoded frame. In at least one embodiment, the computed checksum is computed using a cyclic redundancy check (CRC) algorithm.

At operation 608 of method 600, processing logic can compare the computed checksum with a reference checksum included in the supplemental metadata associated with the decoded frame.

At operation 610 of method 600, processing logic can verify an integrity of the decoded frame based on a result of the comparing.

In at least one embodiment, the processing logic can further determine that the computed checksum is not equivalent to the reference checksum. Responsive to a determination that the computed checksum is not equivalent to the reference checksum, the processing logic can cease to decode subsequent encoded frames of the encoded bitstream.

In at least one embodiment, the processing logic can further determine that the computed checksum is equivalent to the reference checksum. Responsive to a determination that the computed checksum is equivalent to the reference checksum, the processing logic can continue to decode subsequent encoded frames of the encoded bitstream.

In at least one embodiment, the processing logic can further decode the supplemental data for the frame to obtain decoded supplemental metadata and extract the reference checksum from the decoded supplemental metadata.

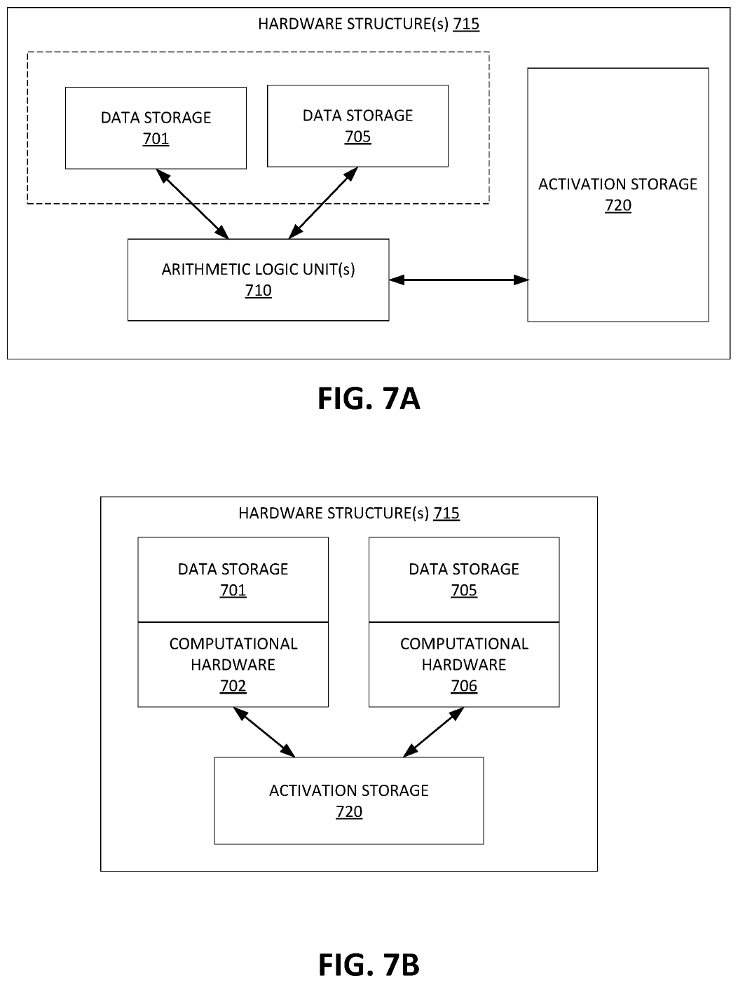

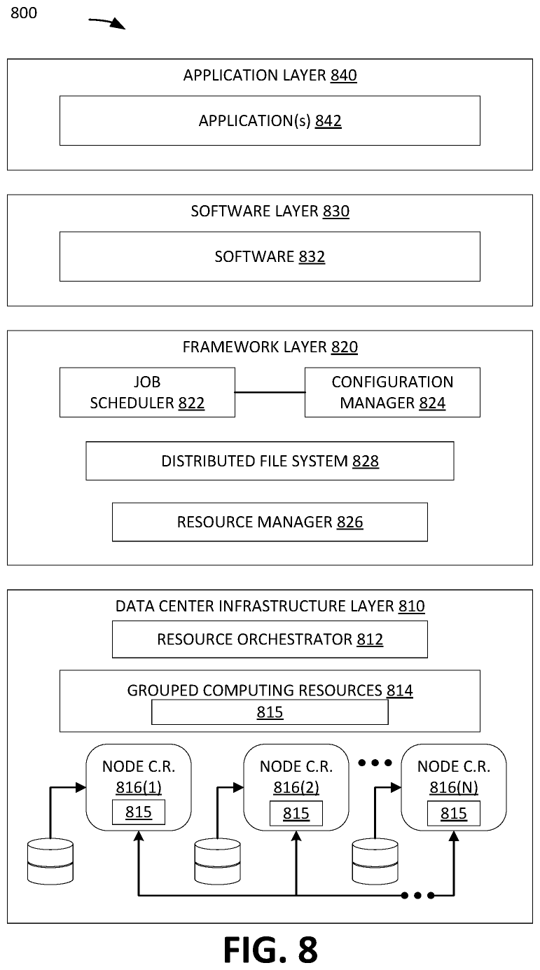

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

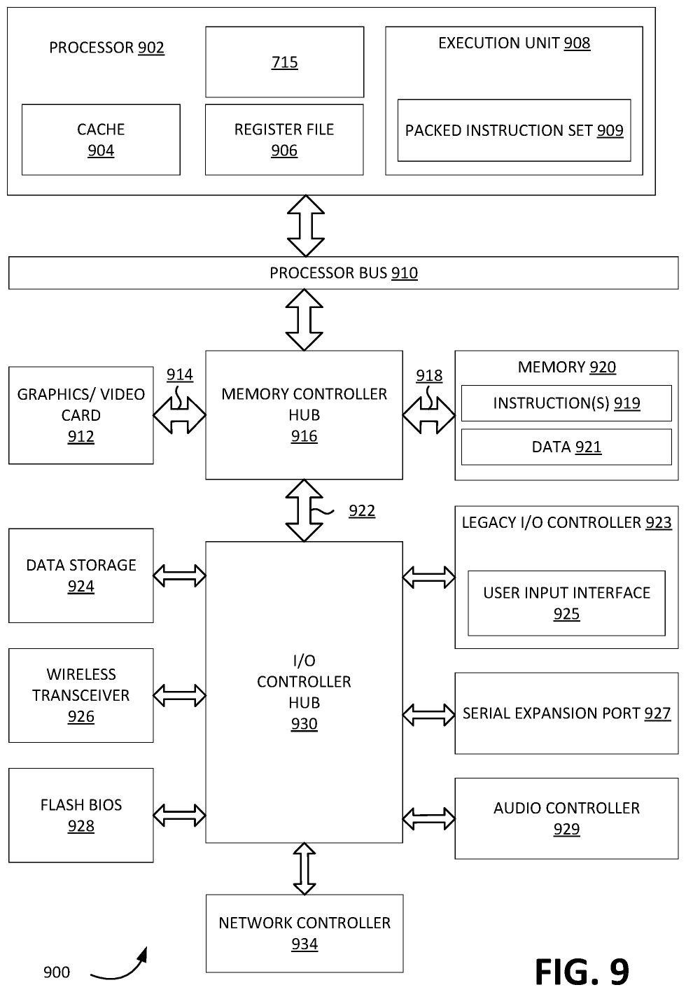

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

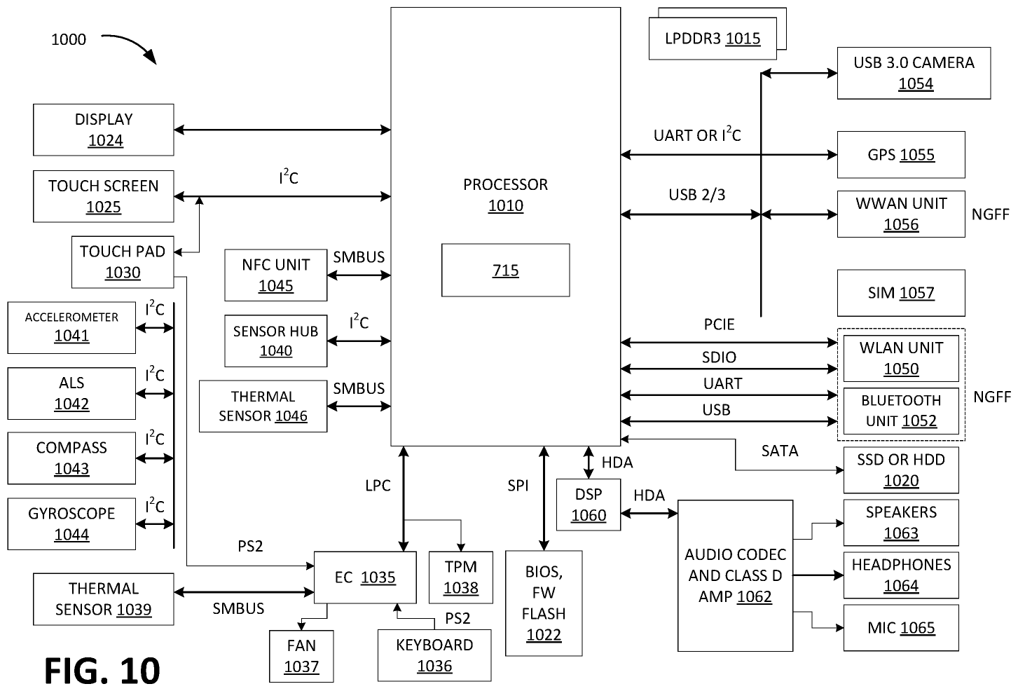

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium® XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934, which may include in some embodiments, a data processing unit. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

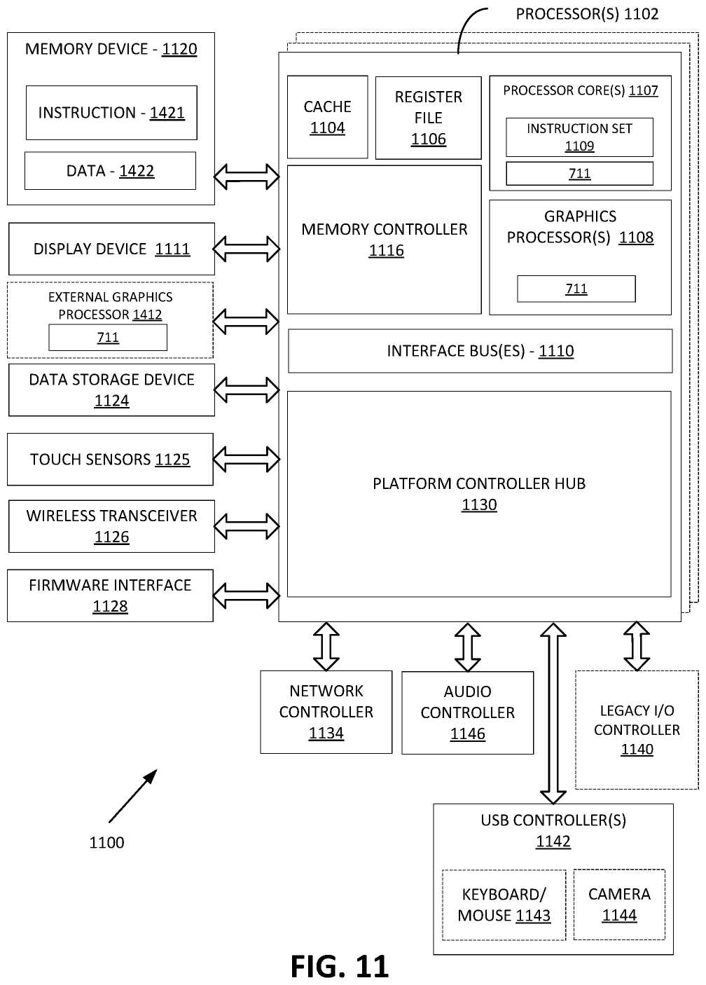

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, system 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1064 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 9A and/or 9B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

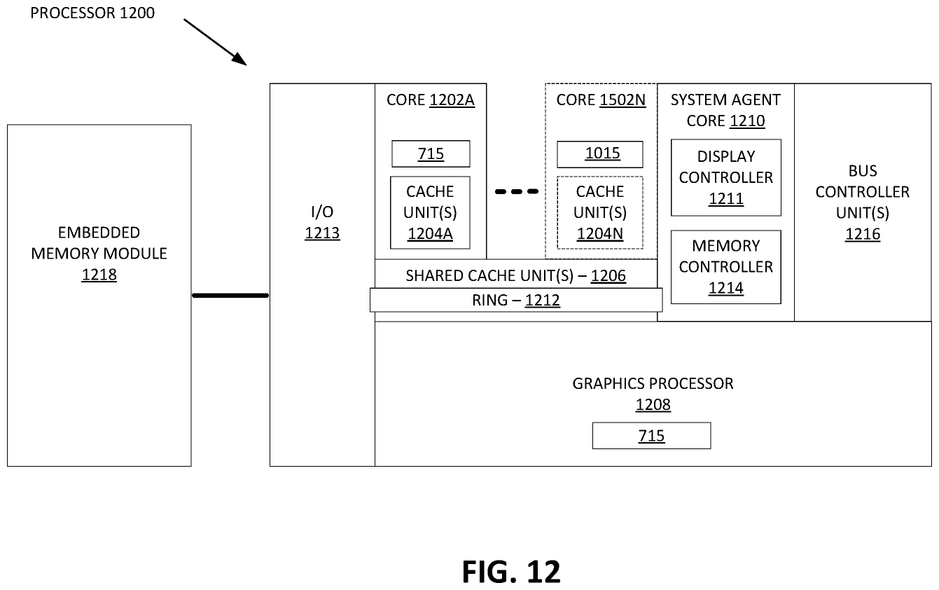

FIG. 11 is a block diagram of a processing system, according to at least one embodiment. In at least one embodiment, system 1100 includes one or more processors 1102 and one or more graphics processors 1108, and may be a single processor desktop system, a multiprocessor workstation system, or a server system having a large number of processors 1102 or processor cores 1107. In at least one embodiment, system 1100 is a processing platform incorporated within a system-on-a-chip (SoC) integrated circuit for use in mobile, handheld, edge, or embedded devices.

In at least one embodiment, system 1100 may include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 may also include, couple with, or be integrated within a wearable device, such as a smart watch wearable device, smart eyewear device, augmented reality device, or virtual reality device. In at least one embodiment, processing system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 may have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in system 1100. In at least one embodiment, interface bus 1110, in one embodiment, may be a processor bus, such as a version of a Direct Media Interface (DMI) bus. In at least one embodiment, interface 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 may be a dynamic random access memory (DRAM) device, a static random access memory (SRAM) device, flash memory device, phase-change memory device, or some other memory device having suitable performance to serve as process memory. In at least one embodiment memory device 1120 may operate as system memory for system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 may connect to processor(s) 1102. In at least one embodiment display device 1111 may include one or more of an internal display device, as in a mobile electronic device or a laptop device or an external display device attached via a display interface (e.g., DisplayPort, etc.). In at least one embodiment, display device 1111 may include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 may connect via a storage interface (e.g., SATA) or via a peripheral bus, such as a Peripheral Component Interconnect bus (e.g., PCI, PCI Express). In at least one embodiment, touch sensors 1125 may include touch screen sensors, pressure sensors, or fingerprint sensors. In at least one embodiment, wireless transceiver 1126 may be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and may be, for example, a unified extensible firmware interface (UEFI). In at least one embodiment, network controller 1134 may enable a network connection to a wired network. In at least one embodiment, a high-performance network controller (not shown) couples with interface bus 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 may also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 may include an external memory controller 1116 and platform controller hub 1130, which may be configured as a memory controller hub and peripheral controller hub within a system chipset that is in communication with processor(s) 1302.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1200. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 7A or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

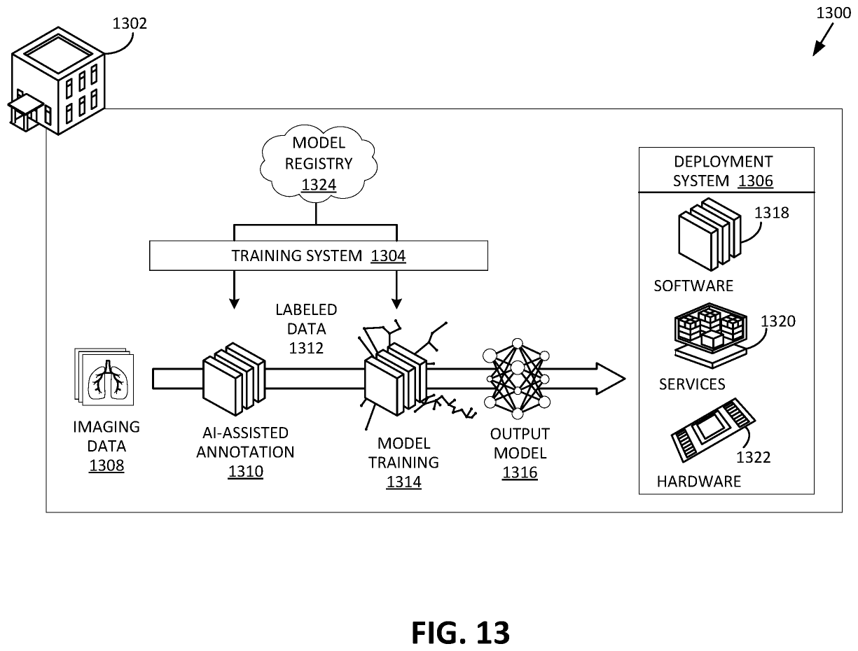

FIG. 12 is a block diagram of a processor 1200 having one or more processor cores 1202A-1202N, an integrated memory controller 1214, and an integrated graphics processor 1208, according to at least one embodiment. In at least one embodiment, processor 1200 may include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 may be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIG. 7A or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

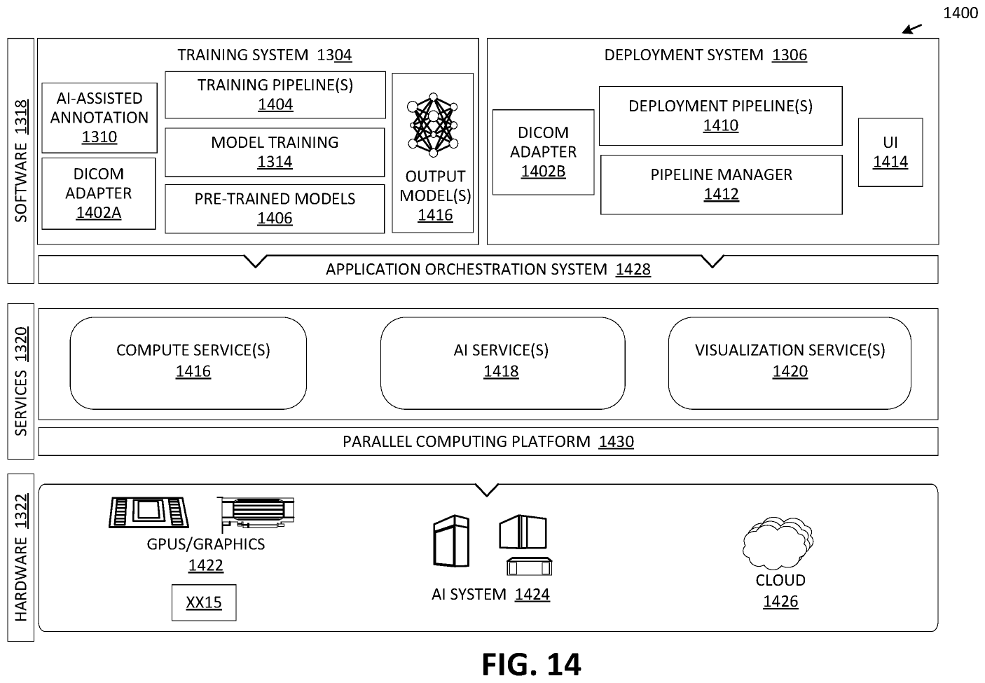

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility (ies), or a combination thereof. In at least one embodiment, training system 1304 may be used to provide applications, services, and/or other resources for generating working, deployable machine learning models for deployment system 1306.

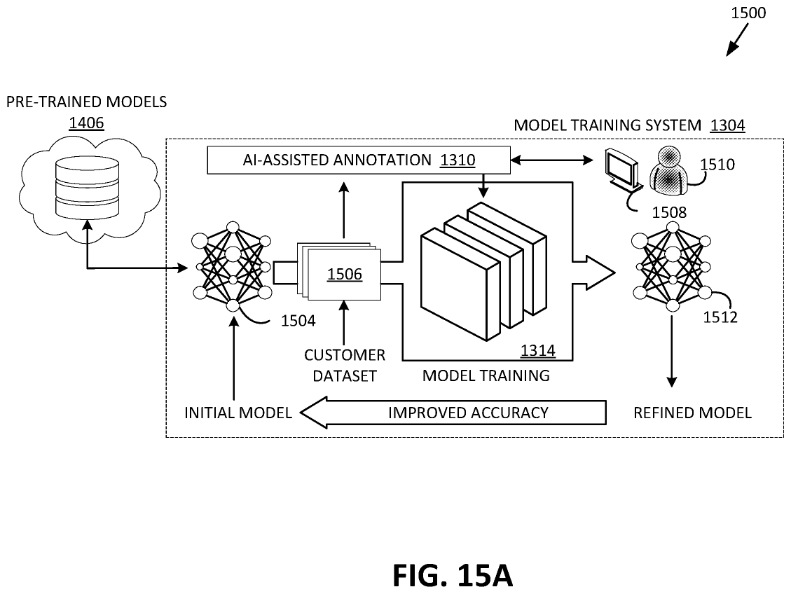

In at least one embodiment, model registry 1324 may be backed by object storage that may support versioning and object metadata. In at least one embodiment, object storage may be accessible through, for example, a cloud storage (e.g., cloud 1426 of FIG. 14) compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1404 (FIG. 14) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotations 1310 may then be used directly, or may be adjusted or fine-tuned using an annotation tool to generate ground truth data. In at least one embodiment, AI-assisted annotations 1310, labeled clinic data 1312, or a combination thereof may be used as ground truth data for training a machine learning model. In at least one embodiment, a trained machine learning model may be referred to as output model 1316, and may be used by deployment system 1306, as described herein.

In at least one embodiment, training pipeline 1404 (FIG. 14) may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model 1316—and may be used in deployment system 1306 to perform one or more processing tasks for one or more applications of a deployment system.

In at least one embodiment, training pipeline 1404 (FIG. 14), a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotations 1310, labeled clinic data 1312, or a combination thereof—may be used as ground truth data for retraining or updating a machine learning model. In at least one embodiment, a trained machine learning model may be referred to as output model 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1400 of FIG. 14). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1400 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1400 of FIG. 14). In at least one embodiment, completed and validated applications or containers may be stored in a container registry and associated machine learning models may be stored in model registry 1324. In at least one embodiment, a requesting entity-who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1430 (FIG. 14). In at least one embodiment, rather than each application that shares a same functionality offered by a service 1320 being required to have a respective instance of service 1320, service 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus (ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipelines 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption. In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1314 and/or pre-trained model(s) 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

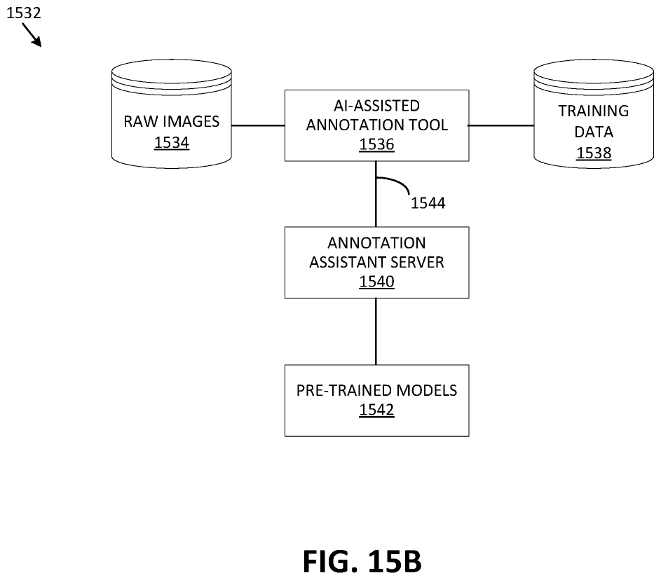

In at least one embodiment, training pipelines 1404 may include AI-assisted annotation, as described in more detail herein with respect to at least FIG. 15B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipelines 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner.

In at least one embodiment, deployment system 1306 may execute deployment pipelines 1410. In at least one embodiment, deployment pipelines 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1410 depending on information desired from data generated by a device. In at least one embodiment, where detections of anomalies are desired from an MRI machine, there may be a first deployment pipeline 1410, and where image enhancement is desired from output of an MRI machine, there may be a second deployment pipeline 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1400—such as services 1320 and hardware 1322—deployment pipelines 1410 may be even more user friendly, provide for easier integration, and produce more accurate, efficient, and timely results.

In at least one embodiment, deployment system 1306 may include a user interface 1414 (e.g., a graphical user interface, a web interface, etc.) that may be used to select applications for inclusion in deployment pipeline(s) 1410, arrange applications, modify, or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, user interface 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to service 1320, and/or from application or service to hardware 1322. In at least one embodiment, although illustrated as included in software 1318, this is not intended to be limiting, and in some examples (e.g., as illustrated in FIG. 12) pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 1320 leveraged by and shared by applications or containers in deployment system 1306 may include compute services 1416, AI services 1418, visualization services 1420, and/or other service types. In at least one embodiment, applications may call (e.g., execute) one or more of services 1520 to perform processing operations for an application. In at least one embodiment, compute services 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1418 may be leveraged to perform inferencing services for executing machine learning model(s) associated with applications (e.g., tasked with performing one or more processing tasks of an application). In at least one embodiment, AI services 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output models 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI services 1418.

In at least one embodiment, shared storage may be mounted to AI services 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1506, and one or more instances may be selected (e.g., for best fit, for load balancing, etc.) to process a request. In at least one embodiment, to process a request, a request may be entered into a database, a machine learning model may be located from model registry 1524 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<12 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization services 1420 may be leveraged to generate visualizations for viewing outputs of applications and/or deployment pipeline(s) 1410. In at least one embodiment, GPUs 1422 may be leveraged by visualization services 1420 to generate visualizations. In at least one embodiment, rendering effects, such as ray-tracing, may be implemented by visualization services 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1420 may include an internal visualizer, cinematics, and/or other rendering or image processing capabilities or functionality (e.g., ray tracing, rasterization, internal optics, etc.).

In at least one embodiment, hardware 1322 may include GPUs 1422, AI system 1424, cloud 1426, and/or any other hardware used for executing training system 1304 and/or deployment system 1506. In at least one embodiment, GPUs 1422 (e.g., NVIDIA's TESLA and/or QUADRO GPUs) may include any number of GPUs that may be used for executing processing tasks of compute services 1416, AI services 1418, visualization services 1420, other services, and/or any of features or functionality of software 1318. For example, with respect to AI services 1418, GPUs 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs 1422, in addition to DPUs, CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system(s) 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute services 1416, AI services 1418, and/or visualization services 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services 1320 and/or hardware 1322 of system 1400, as described herein. In at least one embodiment, refined models 1512 generated by process 1500 may be executed by deployment system 1306 for one or more containerized applications in deployment pipelines 1410.

In at least one embodiment, model training 1314 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, or deleted, and/or replaced with an updated or new output or loss layer(s). In at least one embodiment, initial model 1504 may have previously fine-tuned parameters (e.g., weights and/or biases) that remain from prior training, so training or retraining 1314 may not take as long or require as much processing as training a model from scratch. In at least one embodiment, during model training 1314, by having reset or replaced output or loss layer(s) of initial model 1504, parameters may be updated and re-tuned for a new data set based on loss calculations associated with accuracy of output or loss layer(s) at generating predictions on new, customer dataset 1506 (e.g., image data 1308 of FIG. 13).

In at least one embodiment, pre-trained models 1406 may be stored in a data store, or registry (e.g., model registry 1324 of FIG. 13). In at least one embodiment, pre-trained models 1406 may have been trained, at least in part, at one or more facilities other than a facility executing process 1500. In at least one embodiment, to protect privacy and rights of patients, subjects, or clients of different facilities, pre-trained models 1406 may have been trained, on-premise, using customer or patient data generated on-premise. In at least one embodiment, pre-trained models 1406 may be trained using cloud 1426 and/or other hardware 1322, but confidential, privacy protected patient data may not be transferred to, used by, or accessible to any components of cloud 1426 (or other off premise hardware). In at least one embodiment, where a pre-trained model 1406 is trained at using patient data from more than one facility, pre-trained model 1406 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1406 on-premise and/or off premise, such as in a datacenter or other cloud computing infrastructure.

In at least one embodiment, when selecting applications for use in deployment pipelines 1410, a user may also select machine learning models to be used for specific applications. In at least one embodiment, a user may not have a model for use, so a user may select a pre-trained model 1406 to use with an application. In at least one embodiment, pre-trained model 1406 may not be optimized for generating accurate results on customer dataset 1506 of a facility of a user (e.g., based on patient diversity, demographics, types of medical imaging devices used, etc.). In at least one embodiment, prior to deploying pre-trained model 1406 into deployment pipeline 1410 for use with an application(s), pre-trained model 1406 may be updated, retrained, and/or fine-tuned for use at a respective facility.

In at least one embodiment, a user may select pre-trained model 1406 that is to be updated, retrained, and/or fine-tuned, and pre-trained model 1406 may be referred to as initial model 1504 for training system 1304 within process 1500. In at least one embodiment, customer dataset 1506 (e.g., imaging data, genomics data, sequencing data, or other data types generated by devices at a facility) may be used to perform model training 1314 (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility (e.g., as labeled clinic data 1312 of FIG. 13).

In at least one embodiment, AI-assisted annotation 1310 may be used in some examples to generate ground truth data. In at least one embodiment, AI-assisted annotation 1310 (e.g., implemented using an AI-assisted annotation SDK) may leverage machine learning models (e.g., neural networks) to generate suggested or predicted ground truth data for a customer dataset. In at least one embodiment, user 1510 may use annotation tools within a user interface (a graphical user interface (GUI)) on computing device 1508.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training 1314 to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines 1410 at a facility for performing one or more processing tasks with respect to medical imaging data.

In at least one embodiment, refined model 1512 may be uploaded to pre-trained models 1406 in model registry 1324 to be selected by another facility. In at least one embodiment, his process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tools 1536 may be instantiated based on a client-server architecture 1532. In at least one embodiment, annotation tools 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation 1310, a deep learning model, for example, may receive this data as input and return inference results of a segmented organ or abnormality. In at least one embodiment, pre-instantiated annotation tools, such as AI-Assisted Annotation Tool 1536B in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines 1604. In at least one embodiment, pre-installed annotation tools may be improved over time as new labeled clinic data 1312 is added.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
determining, for an encoded frame of a video, a reference checksum corresponding to the encoded frame;
adding the reference checksum to supplemental metadata associated with the encoded frame of the video; and
transmitting the encoded frame and the supplemental metadata comprising the reference checksum to a recipient to cause the recipient to use the reference checksum to verify an integrity of the frame.

2. The method of claim 1, wherein determining the reference checksum of the frame comprises:
decoding the encoded frame to obtain a decoded frame; and
computing the reference checksum of the decoded frame.

3. The method of claim 1, wherein the reference checksum of the frame is determined using a cyclic redundancy check (CRC) algorithm.

4. The method of claim 1, wherein the supplemental metadata comprises a supplemental enhancement information (SEI) message included within a payload of a Network Abstraction Layer (NAL) unit associated with a video coding standard.

5. The method of claim 1, further comprising:
receiving, at the recipient, the encoded frame and the supplemental metadata comprising the reference checksum;
decoding the encoded frame;
computing a checksum of the decoded frame;
comparing the computed checksum with the reference checksum included in the supplemental metadata; and
verifying an integrity of the decoded frame based on a result of the comparing.

6. The method of claim 5, further comprising:
determining that the computed checksum is not equivalent to the reference checksum; and
responsive to determining the computed checksum is not equivalent to the reference checksum, ceasing to decode subsequent encoded frames of the video.

7. The method of claim 5, further comprising:
determining that the computed checksum is equivalent to the reference checksum; and
responsive to determining the computed checksum is equivalent to the reference checksum, continuing to decode subsequent encoded frames of the video.

8. The method of claim 5, further comprising:
decoding the supplemental metadata to obtain decoded supplemental metadata; and
extracting the reference checksum from the decoded supplemental metadata.

9. A method comprising:
receiving an encoded bitstream comprising a plurality of encoded frames of a video and associated supplemental metadata;
decoding a frame of the encoded bitstream to obtain a decoded frame;
computing a checksum of the decoded frame;
comparing the computed checksum with a reference checksum included in the supplemental metadata associated with the decoded frame; and
verifying an integrity of the decoded frame based on a result of the comparing.

10. The method of claim 9, further comprising:
determining that the computed checksum is not equivalent to the reference checksum; and
responsive to determining the computed checksum is not equivalent to the reference checksum, ceasing to decode subsequent encoded frames of the encoded bitstream.

11. The method of claim 9, further comprising:
determining that the computed checksum is equivalent to the reference checksum; and
responsive to determining the computed checksum is equivalent to the reference checksum, continuing to decode subsequent encoded frames of the encoded bitstream.

12. The method of claim 9, further comprising:
decoding the supplemental metadata for the frame to obtain decoded supplemental metadata; and
extracting the reference checksum from the decoded supplemental metadata.

13. The method of claim 9, wherein the computed checksum is computed using a cyclic redundancy check (CRC) algorithm.

14. The method of claim 9, wherein the supplemental metadata comprises a supplemental enhancement information (SEI) message included within a payload of a Network Abstraction Layer (NAL) unit associated with a video coding standard.

15. A system, comprising:
one or more computing devices comprising a first logic to:
encode a frame of a video;
determine a reference checksum of the frame;
add the reference checksum to supplemental metadata associated with the encoded frame of the video; and
transmit the encoded frame and the supplemental metadata comprising the reference checksum to a recipient, wherein the recipient is to use the reference checksum to verify an integrity of the frame.

16. The system of claim 15, wherein the first logic comprises at least one of a hardware encoder or a software encoder.

17. The system of claim 15, further comprising a second logic to:
receive the encoded frame and the supplemental metadata comprising the reference checksum from the first logic;
decode the encoded frame;
compute a checksum of the decoded frame;
compare the computed checksum with the reference checksum included in the supplemental metadata; and
verify an integrity of the decoded frame based on a result of the comparing.

18. The system of claim 17, wherein the second logic is further to:
determine that the computed checksum is not equivalent to the reference checksum; and
responsive to determining that the computed checksum is not equivalent to the reference checksum, cease to decode subsequent encoded frames of the video.

19. The system of claim 17, wherein the computed checksum and the reference checksum are determined using a cyclic redundancy check (CRC) algorithm.

20. The system of claim 17, wherein the second logic comprises at least one of a hardware decoder or a software decoder.
